(19) United States
(12) Patent Application Publication
(10) Pub. No.: US 2006/0175155 A1
(43) Pub. Date: Aug. 10, 2006

(54) Pneumatically or electromotively operated disc brake

(75) Inventors: Franz Gasslbauer, Johanniskirchen (DE); Mario Springer, Eging (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme Fuer Nutzfahrzeuge GmbH, Muenchen (DE)

(21) Appl. No.: 11/331,059

(22) Filed: Jan. 13, 2006

Related U.S. Application Data
(63) Continuation of application No. PCT/EP04/07705, filed on Jul. 13, 2004.

(30) Foreign Application Priority Data
Jul. 15, 2003 (DE) 103 31 929.8

(51) Int. Cl. F16D 55/08

(52) U.S. Cl. 188/72.7

(57) ABSTRACT

A disc brake, operated pneumatically or by electromotor, for a commercial vehicle, has a brake caliper straddling a brake disc and at least one operating device, for application to the brake disc, whereby an actuator spindle includes a pressure piece on the side thereof facing the brake disc and a bellows is connected thereto or to parts connected therewith for sealing the exit region of the actuator spindle from the brake caliper. In order to provide a thermal break between the pressure piece and the actuator spindle, a heat shield is directly or indirectly connected to the bellows, which at least covers the front face of the actuator spindle facing the pressure piece.

### CROSS-REFERENCE TO RELATED APPLICATIONS

This application is a Continuation of PCT Application No. PCT/EP2004/007705, filed on Jul. 13, 2004, which claims priority of German Application No. 103 31 929.8, filed Jul. 15, 2003, the disclosure of which is expressly incorporated by reference herein.

### BRIEF DESCRIPTION AND SUMMARY OF THE INVENTION

The invention relates to a pneumatically or electromotively operated disc brake, in particular, one for a commercial vehicle, having a brake caliper which straddles a brake disc, and having at least one brake application device for applying the brake disc, wherein at least one adjusting spindle, on its side facing toward the brake disc, has a pressure piece and, for the sealing of the exit region of the adjusting spindle from the brake caliper, a bellows is connected to the latter or to parts fastened thereto.

The basic structure of such a disc brake is known, for example, from German Patent document DE 195 15 063 C2.

The disc brake, which is shown and described therein, has a brake application device having two adjusting spindles, which are displaceably mounted in the brake caliper. At the brake-disc-facing end of the two spindles there is, respectively disposed, a pressure piece. The pressure pieces support a brake pad, which, during functioning, makes contact with a brake disc.

In order to protect the interior of the brake caliper and the adjusting spindles from dirt contamination, in the respective exit region of the adjusting spindle from the brake caliper there is disposed a bellows, which is fastened to a closing plate by which the brake caliper is closed off. In this regard, the closing plate is a constituent part of the brake caliper, to which the bellows can also be directly fastened if no closing plate is provided. On the other hand, the bellows is fastened to the pressure piece, which, additionally, is directly connected to the adjusting spindle.

The disc brakes which are usually fitted in commercial vehicles are subjected during operation, and under the frictional heat which is generated, to a considerable thermal load, which, emanating from the brake pad, continues via the connected metal pressure pieces, and the adjusting spindles connected thereto, to inside the brake caliper and on to relevant parts of the brake application device.

Equally, the bellows fastened to the pressure piece is subjected to heat, whereby the working life of the bellows, which consists of a plastic or a similar material, is reduced.

The not inconsiderable thermal loading of those functional parts precludes a sought-after optimized service life, so that relatively short maintenance intervals are necessary in order to permanently ensure operating reliability.

Of course, not only the maintenance and service work per se, but also the load-dictated necessary replacements of components, are connected with considerable costs, both in terms of their procurement and in terms of the assembly and disassembly, as well as the necessary downtime of the vehicle.

An aspect of the present invention is therefore to refine a disc brake of the above-mentioned type such that its service time interval is increased and repair costs are consequently lowered.

This aspect may be achieved by a disc brake, for a commercial vehicle, having a brake caliper which straddles a brake disc, and having at least one brake application device for applying the brake disc, wherein at least one adjusting spindle, on its side facing toward the brake disc, has a pressure piece and, for the sealing of the exit region of the adjusting spindle from the brake caliper, a bellows is connected to the latter or to parts fastened thereto. Between the pressure piece and the adjusting spindle, a heat shield is connected directly or indirectly to the bellows, which heat shield covers at least that end face of the adjusting spindle which faces toward the pressure piece.

According to the invention, for forming a thermal break between the pressure piece and the adjusting spindle, a heat shield is connected directly or indirectly to the bellows. The heat shield covers at least that end face which faces toward the pressure piece. A direct contact between the pressure piece and the adjusting spindle thus no longer exists, so that nor, any longer, does an excessive heat transfer take place from the pressure piece to the adjusting spindle.

Correspondingly, the heating of adjoining components, such as, for example, a cross member in which the adjusting spindle is guided, as well as of the brake application device, is thereby actively reduced. Equally, a heating of the interior of the brake caliper and of the adjoining components through radiant heat is prevented.

Thus, the invention helps significantly to increase the service life of the disc brake, i.e. to lengthen the repair intervals and inspection intervals.

This, of course, yields a cost reduction compared with a disc brake according to the prior art, to which reduced assembly and material costs also contribute.

The heat shield consists of a material having lower heat conductivity than the other material of the pressure pieces and can be applied as a coating to a pot element, which is fastened in an axially secure manner to the adjusting spindle, which, however, is held in a freely rotatable manner in the pot element. This type of fastening may be realized by a circumferential annular groove in the adjusting spindle, in which the pot element, by virtue of an appropriate add-on molding, positively engages.

In place of a coating of the pot element, i.e. a composite coating, the heat shield may also be designed as a separate part, for example in the form of a plate covering the end face of the adjusting spindle. Where appropriate, it may also adjoin side regions. The plate is disposed virtually between the pot element and the adjusting spindle.

The pot element, expediently configured as a sheet-metal molding, is connected to the bellows by surrounding injection molding, to be precise circumferentially. Since the bellows, on the other hand, is fastened either directly to the brake caliper or, for example, to a closing plate, the exit region of the adjusting spindle from the brake caliper is hermetically sealed, so that no dirt particles can get into the interior of the brake caliper or onto the adjusting spindle and the threads thereof.

As a result of the direct binding of the bellows to the pot element, which, as mentioned, is connected to the adjusting spindle, a hitherto necessary secondary seal and associated components can be dispensed with. Consequently and as a result of the simple, yet very effective nature of the securement of the bellows on the adjusting spindle through binding to the pot element, an economical production and an inexpensive assembly and disassembly are obtained. The pot element/heat shield unit can here be used in different embodiments of the disc brake. Thus, the assigned pressure piece can be connected to the pot element, for example. It is also contemplated, however, to use the pot element with heat shield in a design in which the pressure piece is an integral component of the brake pad or of a brake lining carrier.

The securement of the protective-plate-forming pot element to the bellows in the sense of the surrounding injection molding may be realized, for example, with a suitable elastomer, preferably a silicone rubber. In any event, the now no longer direct binding of the bellows to the pressure piece has the effect that the bellows, too, is exposed to a lesser thermal load, which, inter alia, means that the bellows too may be used throughout several changes of the brake pads, thereby also, of course, producing cost benefits.

The heat shield may be placed as a separate plate loosely between the pot element and the facing end face of the adjusting spindle. There is also the possibility, however, of connecting the heat shield as a separate part to the pot element or the adjusting spindle, for which the elastomer is suitable, which then serves virtually as a connecting mechanism.

Other objects, advantages and novel features of the present invention will become apparent from the following detailed description of the invention when considered in conjunction with the accompanying drawings.

### BRIEF DESCRIPTION OF THE DRAWINGS

An illustrative embodiment of the invention is described below with reference to the appended drawings, in which:

FIG. 1 is a partial-representation of a disc brake in a sectional plan view,

FIG. 2 shows a detail of the disc brake in a sectional representation; and

FIG. 3 shows a detail from FIG. 2, likewise in sectional representation.

### DETAILED DESCRIPTION OF THE DRAWINGS

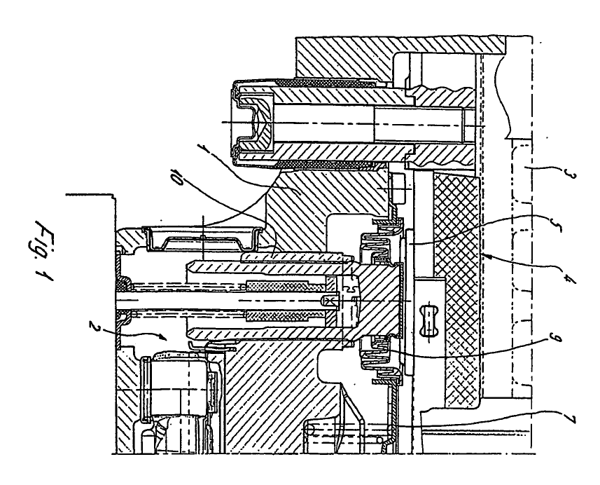

In FIG. 1, one quarter of a pneumatically operated disc brake is represented, which disc brake has a brake caliper 1, which is configured as a sliding caliper and straddles a brake disc 3 in its upper peripheral region. In place of a pneumatic actuation, an electromotive operation of the disc brake is also possible.

Disposed on both sides of the brake disc 3 are brake pads 4 (here, represented only on one side). Here, one brake pad is shown fastened to or bearing against a pressure piece 5, by which the assigned brake pad 4 can be pressed against the brake disc 3.

The pressing of the brake pad against the disc is done by a brake application device 2, which is operated by a rotary lever and is connected to at least one adjusting spindle 10 supporting a respective pressure piece 5 and guided in an axially movable manner in the brake caliper 1.

Only one pressure piece 5, together with the associated components, is represented and described herein. A preferred construction, however, has two pressure pieces 5 on a respective side of the disc.

In the present illustrative embodiment, the brake caliper 1 is largely closed off, on its side facing toward the brake disc 3, by a closing plate 7, which is pierced in the exit region of the adjusting spindle 10.

For sealing the exit region of the adjusting spindle 10 from the brake caliper 1, a bellows 9 connected to the closing plate 7 is respectively provided, which, on the other hand, is connected to the adjusting spindle 10.

In the case of a configuration of the brake caliper 1, wherein the closing plate 7 is dispensed with, then the bellows 9 are fastened directly to the brake caliper 1, e.g. pressed in place.

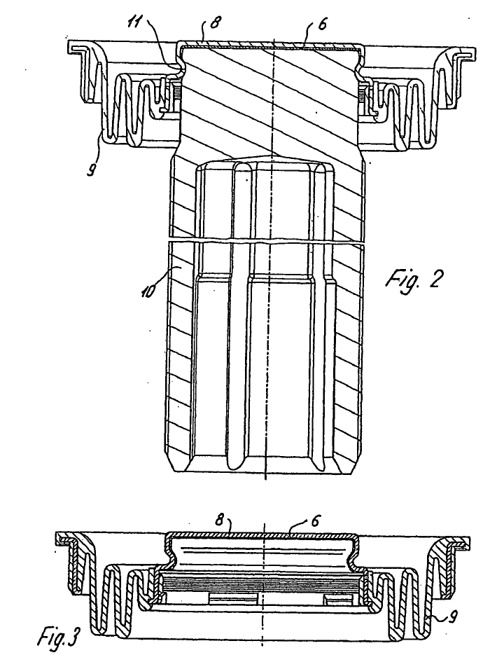

In FIG. 2, it is clearly apparent that, for providing a thermal break between the pressure piece 5 (not shown) and the adjusting spindle 10, a heat shield 6 made of a low-conductivity material is provided. The heat shield 6 covers that end face of the adjusting spindle 10 which faces toward the pressure piece 5.

The heat shield 6 according to FIG. 2 is configured as a separate plate and bears against the end face of the adjusting spindle 10.

The heat shield 6 is covered and held by a pot element 8, which engages positively in an annular groove 11 in the adjusting spindle 10 such that it is axially secured, yet the adjusting spindle 10 is freely rotatable.

The bellows 9 are connected to the pot element 8, preferably through encapsulating injection molding using a suitable material, for example an elastomer and in this case, preferably, silicone rubber.

The opposite, in this regard free edge of the bellows 9 is fixedly connected to the closing plate 7 or, in another case, directly to the brake caliper 1, so that both the bellows 9 and the pot element 8 are held in a torsionally secure manner relative to the adjusting spindle 10.

Bearing against that side of the pot element 8 which lies opposite the adjusting spindle 10 is the pressure piece 5, which can be fixedly connected to the pot element 8 or, if the pressure piece 5 is an integral component of the brake pad 4, is only operatively connected thereto, i.e. in a loosely adjacent manner.

In FIG. 3, as a detail view, the pot element 8 is represented with the connected bellows 9, the pot element 8 being provided on the inner side with a coating which forms the heat shield 6.

In any event, the bellows 9 is now no longer directly fastened to the pressure piece 5, as in the state of the art, but rather indirectly to the adjusting spindle 10, whereby heat transfer emanating from the pressure piece 5 is actively prevented.

### TABLE OF REFERENCE NUMBERS

1 brake caliper
2 brake application device
3 brake disc
4 brake pad
5 pressure piece
6 heat shield
7 closing plate
8 pot element
9 bellows
10 adjusting spindle
11 annular groove

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A pneumatically or electromotively operated disc brake for a commercial vehicle, comprising:
a brake caliper which straddles a brake disc when in use;
at least one brake application device arranged in the caliper for applying the disc brake, the brake application device including at least one adjusting spindle which, on a longitudinal end face facing toward the brake disc when in use has a pressure piece;
a bellows configured to seal an exit region of the adjusting spindle from the brake caliper; and
a heat shield coupled with the bellows, the heat shield being arranged between the pressure piece and the adjusting spindle so as to cover at least the longitudinal end face of the adjusting spindle facing toward the pressure piece.

2. The disc brake as claimed in claim 1, wherein the heat shield is configured as a separate plate, which heat shield is held by a pot element secured on the adjusting spindle.

3. The disc brake as claimed in claim 2, wherein the pot element is connected to the bellows in a torsionally secure manner.

4. The disc brake as claimed in claim 2, wherein the pot element is connected to the bellows by encapsulating injection molding using an elastomer.

5. The disc brake as claimed in one claim 4, wherein the elastomer is silicone rubber.

6. The disc brake as claimed in claim 4, wherein the heat shield is connected by the elastomer to the pot element or the adjusting spindle.

7. The disc brake as claimed in claim 2, wherein the heat shield is configured as a coating applied to an inner side of the pot element which faces toward the adjusting spindle.

8. The disc brake as claimed in claim 2, wherein the pot element is secured in an axially secure manner to the adjusting spindle, which is freely rotatable relative to the pot element and the connected bellows.

9. The disc brake as claimed in claim 2, wherein the adjusting spindle has a circumferential annular groove, in which the pot element lies in a positively locking manner.

10. The disc brake as claimed claim 2, wherein the pot element is connected to the pressure piece.

11. The disc brake as claimed claim 2, wherein the pot element bears against the pressure piece, which pressure piece is integrally connected to a brake pad.

12. A pneumatically or electromotively operated disc brake having a brake caliper which straddles a brake disc when in use and at least one brake application device arranged in the brake caliper for applying the disc brake, the disc brake comprising:
at least one adjusting spindle of the brake application device;
a pressure piece operatively configured on a longitudinal end face of the adjusting spindle which faces toward the brake disc when in use;
a bellows operatively configured to seal an exit region of the adjusting spindle from the brake caliper;
a heat shield arranged between the pressure piece and the adjusting spindle, the heat shield covering at least the longitudinal end face of the adjusting spindle and being coupled with the bellows;
a pot element operatively configured to secure the heat shield to the adjusting spindle; and
wherein the heat shield is connected by way of an elastomer, as a separate plate, to the pot element or the adjusting spindle.

13. A disc brake component of a pneumatically or electromotively operated disc brake for a commercial vehicle, comprising:
an adjusting spindle of a brake application device;
a pressure piece operatively arranged at one longitudinal end of the adjusting spindle;
a sealing bellows coupled to the adjusting spindle or the pressure piece;
a heat shield directly or indirectly coupled to the bellows, the heat shield being arranged between the pressure piece and the adjusting spindle so as to cover at least the one longitudinal end of the adjusting spindle which faces toward the pressure piece; and
a pot element for securing the heat shield on the adjusting spindle.

14. The disc brake component according to claim 13, wherein the heat shield is a separate plate and wherein the pot element is coupled to the bellows in a torsionally secure manner.

15. The disc brake component according to claim 13, wherein the pot element is coupled to the bellows by injection molding encapsulation using an elastomer.

16. The disc brake component according to claim 15, wherein the elastomer is silicone rubber.

17. The disc brake according to claim 16, wherein the heat shield is connected by way of the elastomer to the pot element or the adjusting spindle.
